(19) United States
(12) Patent Application Publication
(10) Pub. No.: US 2024/0231300 A1
(43) Pub. Date: Jul. 11, 2024

(54) AUTOMATIC OPTIMIZATION FRAMEWORK FOR SAFETY-CRITICAL SYSTEMS OF INTERCONNECTED SUBSYSTEMS

(71) Applicant: Ground Transportation Systems Canada Inc., Toronto (CA)

(72) Inventors: Mohamed HELWA, Toronto (CA); Veronica MARIN, Toronto (CA)

(21) Appl. No.: 18/399,964

(22) Filed: Dec. 29, 2023

Related U.S. Application Data
(60) Provisional application No. 63/478,004, filed on Dec. 30, 2022.

(51) Int. Cl. G05B 19/042

(52) U.S. Cl. CPC G05B 19/0428; G05B 2219/24024

(57) ABSTRACT

A method for automatically optimizing the parameters of a safety-critical system of interconnected subsystems. The method includes selecting a representative sample data set for parameter optimization; breaking the complexity of optimizing a high-dimensional system of interconnected subsystems; exploring the parameter space of each subsystem for parameter setting of the subsystem; determining parameter setting of the system of systems; and justifying the parameter selection to achieve certification of safety-critical system of systems.

### PRIORITY CLAIM

The present application claims the priority of U.S. Provisional Application No. 63/478,004, filed Dec. 30, 2022, which is incorporated herein by reference in its entirety.

### BACKGROUND

The technical domain of one or more embodiments is complex safety-critical system of systems in rail industry and beyond. Other applications include, but are not limited to, autonomous ground/sea/aerial vehicles, cars, airplanes, robots, and industrial manufacturing, or the like, among others.

Parameter tuning was typically performed manually in rail applications and other industries according to other approaches. In particular, designers manually select the parameter values of each module/component in the system based on theoretical justification/rationale of the role of each parameter, and in some instances evaluation of the component performance based on limited data using design experts' judgement. However, modern systems are quite complex and typically contain interconnecting subsystems with a large number of parameters. Hence, manual tuning is not efficient because: (1) it includes a huge amount of trial-and-error efforts for complex systems, (2) designers manually tune on limited data that may not be representative of all real operating conditions (including edge case scenarios related to system safety), (3) manual tuning of individual subsystems/components does not systematically consider the effects of the interconnections between the subsystems in the complex system of systems. Indeed, the change of parameters of one subsystem may require changing the parameter values of other subsystems for optimized performance of the overall complex system. Repeating the manual tuning of some subsystems is very time consuming, not systematic, and does not guarantee the convergence to optimal parameter setting of the overall system of systems.

In machine learning, a hyperparameter is a parameter whose value is used to control the learning process. By contrast, the values of other parameters are derived via training. With the emerging increase in complexity of systems and use of machine learning techniques, optimization methods have been developed for optimal selection of hyperparameters and/or parameters of machine learning modules (for example, Adam optimization technique for selecting deep neural networks weights based on training data). However, these optimization techniques are very specific to particular machine learning components, and do not extend to any complex system of systems. Indeed, these optimization methods do not address the real challenge of how to optimize complex industrial system of interconnected subsystems of different types including traditional as well as machine learning functions, sensor interfaces, supervisions, alarms, etc. These optimization methods also do not provide a full framework of how to select the data to ensure that all edge case scenarios are considered in the parameter optimization, and/or how to build the justification of parameter selection which is needed for safety-critical systems.

There are also hyperparameter optimization methods in the open literature (e.g., grid search, random search, F-race, CALIBRA, Gender Genetic Algorithm (GGA), ParamILS, and Sequential model-based algorithm configuration (SMAC)). However, these optimization methods typically suffer from the curse of dimensionality, especially for very complex industrial systems with 100+ parameters, and they are not (on their own) best suited to handle complex interconnected subsystems for which optimizing the overall system of subsystems is not feasible in one step without leveraging the structure of the system. These optimization approaches also do not provide a full framework of how to select the data to ensure that all edge case scenarios are considered in the parameter optimization or how to build the justification of parameter selection for safety-critical systems.

### BRIEF DESCRIPTION OF THE DRAWINGS

Aspects of embodiments described herein are best understood from the following detailed description when read with the accompanying figures. It is noted that, in accordance with the common practice in the industry, various features are not drawn to scale. In fact, the dimensions of the various features may be arbitrarily increased or reduced for clarity of discussion.

FIG. 1 is a flow diagram of a method, in accordance with some embodiments.

FIG. 2 is a high-level flow diagram of a method, in accordance with some embodiments.

FIG. 3 is a high-level diagram of a system, in accordance with some embodiments.

FIG. 4 is a high-level diagram of a method, in accordance with some embodiments.

FIG. 5 is a high-level diagram of a processing system, in accordance with some embodiments.

### DETAILED DESCRIPTION

Embodiments described herein provide examples for implementing different features of the provided subject matter. Specific examples of components, values, operations, materials, arrangements, or the like, are described below to simplify the embodiments described herein. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, embodiments described herein are able to repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Safety-critical complex systems of systems typically have 100+ configuration parameters for sub-systems, functions, supervisions, alarms, interfaces, or the like. Embodiments described herein provide an automated framework for efficient yet comprehensive exploration of the parameter space before final deployment of safety-critical complex systems. Embodiments of a framework described herein maximize the set of user-defined performance metrics while satisfying safety constraints on parameter bounds, which save manual trial-and-error tuning efforts during design and validation phases. One or more embodiments define the algorithms for handling large-scale mixed-variable problems with multiple objectives. One or more embodiments also integrate the use of data analytics and failure injection as a method to optimize and validate systems parameters under edge scenarios that could lead to system failures. One or more embodiments of the optimization framework described herein provide the justification and evidence for the parameter selection to achieve the certification of safety-critical systems of systems.

One or more embodiments are in the domain of automatic parameter optimization of safety-critical systems of systems in rail applications and beyond. Other applications include, but are not limited to, autonomous systems, aerospace, robotics, and industrial manufacturing, or the like, among others. One or more features of one or more embodiments include the ability of handling high-dimensional complex system of interconnected subsystems without suffering from the curse of dimensionality as in existing hyperparameter optimization approaches, the suitability of the framework for safety-critical systems, and the automated framework for finding representative sample data sets for optimization covering all the operational and environmental conditions of the system including edge case scenarios.

Another approach for an efficient framework for automatically optimizing the parameters of a complex, large-scale, safety-critical system of interconnected subsystems is missing. One or more embodiments provide a method to optimize the performance of complex industrial systems, to speed up testing and validation of new systems by saving significant trial-and-error efforts of manual tuning, and ensure that the selected parameters are optimized for all possible operational and environmental conditions to be faced by the system including edge cases (avoid parameters overfitting), and to provide systematic justification of parameter selection for safety audits (for certification of safety-critical systems). Nevertheless, there is no existing parameter optimization approach that combines substantially all the aforementioned benefits.

Manual tuning incorporates huge trial-and-error efforts, is typically not systematic, is highly subject to overfitting, and does not guarantee reaching an optimal setting of the overall complex system of systems. In some embodiments, retuning of some subsystems (additional manual tuning efforts) is also needed when other subsystems are changed.

Machine learning hyperparameter optimization approaches (e.g., Adam optimizer for deep neural networks) are mainly designed for specific module types, and cannot handle a generic system of interconnected subsystems of different types including sensor interfaces, traditional processing functions, filters, estimators, controllers, AI components, supervisions, alarms, or the like. Machine learning hyperparameter optimization approaches are also not suited for safety-critical systems.

Existing hyperparameter optimization approaches (e.g., grid search, ParamILS, SMAC) do not leverage the structure of the high-dimensional system of interconnected subsystems, and hence, they typically suffer from the curse of dimensionality which prevents them from being applied to very complex industrial systems. These optimization approaches are also not suited for safety-critical systems, and they do not provide a complete framework for selecting a representative data set for optimization to ensure coverage of all operational scenarios including edge cases.

The existing known approaches exhibit some or all of the following problems. Existing methods typically are restricted to low/moderate dimensional systems as existing methods do not leverage the structure of the complex system of interconnected subsystems, and directly use instead iterative machine learning optimization techniques. Hence, existing methods are subject to the well-known curse of dimensionality issue and cannot be directly applied to high-dimensional system of systems. Existing methods cannot be applied to any generic safety-critical system of interconnected subsystems, and are restricted to one type of system or machine learning module. Found parameter optimization methods lack the considerations for safety-critical systems, including (i) ensuring that edge case scenarios from safety analysis (e.g., FMEA, FTA, STPA) are considered in the optimization data set (instead of tuning on nominal data that typically does not have failures) and (ii) imposing constraints on the optimization problem to ensure that the target Safety Integrity Level (SIL) requirements (e.g., failure rate per hour) are met in selected parameter configuration. Lack of a systematic procedure for creating representative sample data set for optimization: Other optimization approaches do not provide a systematic, detailed methodology for creating a representative sample data set for optimization, and therefore does not ensure that the data used in parameter optimization covers all possible operational and environmental conditions of the system, including edge case scenarios. Hence, these methods are highly subject to overfitting on nominal field data scenarios used in the tuning.

Embodiments described herein provide a method that provides one or more advantages. For example, one or more embodiments described herein resolve one or more of the shortcomings of existing methods described above. First, one or more embodiments described herein eliminate the need for manual trial-and-error tuning which saves time, effort and hence money. Second, the optimization is done on a representative sample data, which ensures that the parameters are not overfitting limited data set as is typically the case for manual tuning. Third, the proposed method according to one or more embodiments is generic enough to be applicable to any complex, safety-critical system of systems and it is not tied to a particular module type as in deep learning optimizers (e.g., Adam optimizer). Fourth, the method according to one or more embodiments leverages the structure of interconnected subsystems which makes it suitable for optimizing complex, high-dimensional system of systems. Note this is an advantage over the existing hyperparameter optimization methods which suffer from the curse of dimensionality when trying to optimize directly the overall system of systems. Fifth, the method according to one or more embodiments is designed for safety-critical systems, while existing hyperparameter optimization methods do not consider the SIL requirements of safety-critical systems and typically tune on nominal field data that does not contain edge cases or synthetic failure scenarios from safety analysis. In addition to the above advantages over the existing approaches, the method according to one or more embodiments is modular in the sense that it builds upon finding first the optimal setting for each subsystem in the system of systems. Hence, state-of-the-art optimization approaches of machine learning modules are able to be used to find the optimal setting of a machine learning component without losing the merit of the overall approach as described in embodiments herein.

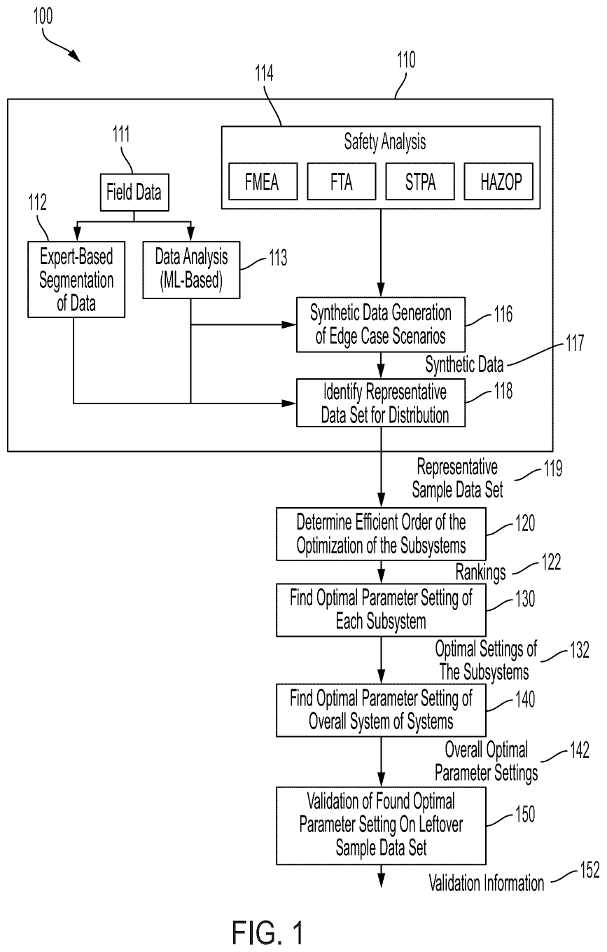

FIG. 1 illustrates an automated framework 100 for efficient parameter optimization of complex, safety-critical systems of interconnected subsystems according to at least one embodiment.

The automated framework 100 provides a hybrid approach according to at least one embodiment that involves selecting a representative sample data set for parameter optimization from both field data and synthetic data of edge case scenarios from the safety analysis, while incorporating both experts' knowledge and advanced data analytics. Incorporating safety requirements for SIL certification in the process of parameter selection facilitates the certification of safety-critical systems.

FIG. 1 shows the 5 steps of the automated framework 100: Identification of a representative sample data set for optimization 110, Ordering for optimization of the subsystems 120, Local optimization/search 130, Determining an optimal setting of the system of subsystems 140, and Validation of found parameters 150.

Identification of a representative sample data set for optimization 110 includes providing Field Data 111 to Expert-Based Segmentation of Data 112 and Data Analytics (ML-Based) 113 for selecting a representative sample data set for parameter optimization. Field Data 111 refers to real data collected from running the physical system, e.g., data collected from revenue trains in rail. The Expert-Based Segmentation of Data 112 for operational & environmental conditions is combined with Data Analytics (Machine Learning (ML)-based) 113 for finding factors that may be overlooked by the designers/experts. Expert-Based Segmentation of Data 112 is data that is based on factors that are important in analyzing the collected field data defined by experts. For example, experts may decide that it is important to segment the data based on factors such as: clear weather, adverse weather conditions (rainy, snowy, ice, cloudy, etc.), rush hour vs non-rush-hour operation, manual vs automatic driving modes, working day data vs weekend data, segment of the track from which data is collected, guideway topology (straight track vs curved track, flat vs uphill vs downhill), and the like. Thus, expert-based selection of data segmentation factors is combined with machine-learning-based segmentation of data including but not limited to clustering approaches, approaches for finding nominal/anomaly behaviours in the data, and feature extraction approaches.

Safety Analysis 114 incorporates synthetic failure injection in real-world data to end up with augmented data (of field & synthetic data) including edge case scenarios identified in qualitative safety analysis. Safety Analysis 114 injects failure scenarios, e.g., defined from Failure Mode and Effect Analysis (FMEA), Fault-Tree Analysis (FTA), System-Theoretic Process Analysis (STPA), Hazard and Operability (HAZOP), and that cannot be closed using only qualitative analysis, to Synthetic Data Generation of Edge Case Scenarios 116 that is able to be generated for anomalous scenarios defined by the Data Analytics (ML-based) 113. Failure scenarios include hardware failure of one of the sensors of the system, late input from one of the sensors, and the like. In order to close some of the failures (similar to the examples provided above, e.g., hardware failure of sensors), a qualitative argument is not enough. Instead, the failure rate per hour (chance of occurrence of safety hazards) is determined to be below the tolerable hazard rate (THR) quantitatively. For SIL4 integrity in rail according to CENELEC standards, the THR is less than 10⁻⁹. Synthetic Data 117 for all the edge case scenarios (identified in the Safety Analysis 114) is generated as part of the data set for optimization.

The Synthetic Data 117 is generated for each residual risk scenario and is provided as input to the system of systems, and the system output is recorded. Synthetic data can include, for example, synthetic failure injections on the existing field data. One or more embodiments use this synthetic data of residual risk/edge case scenarios in addition to the sample field data in the parameter optimization process, in order to claim sufficient data coverage in the optimization process, i.e., the optimization is not happening based only on nominal data while overlooking the challenging data which is the most relevant to the system safety.

Next, for each identified residual risk scenario in the safety analysis, the output of the system of systems for a configuration of parameters under test is evaluated using the system response to the generated Synthetic Data 117. In particular, for each execution cycle of the system, an assessment of whether the system passes or fails the evaluation is performed, and then each execution cycle is tagged as pass or fail. One way of considering the evaluation as failing at an execution cycle is when the system fails to flag/alarm the risk/hazard and the error in the output of the system exceeds a prescribed alarm limit.

Identity of a Representation Sample Data set for Optimization 118 identifies a Representative Sample Data Set 119 for optimization based on the Synthetic Data 117, the input from the Data Analytics (ML-based) 113, and the input from the Expert-Based Segmentation of Data 112. The Representative Sample Data set 119 covers all the operational and environmental conditions of the system including edge case scenarios. Field Data 111 and Synthetic Data 117 of edge case scenarios are combined to ensure coverage of all important scenarios in the parameter optimization of the safety critical system.

The automated framework 100 provides sufficient data coverage of all important operational & environmental conditions of the system in the representative sample data set for optimization which is for avoiding overfitting issue and for building a strong justification of the safety of the system.

Ordering for Optimization of the Subsystems 120 breaks the complexity of high-dimensional system of systems. Embodiments described herein though cover any systematic approach for ranking the subsystems of a complex system of interconnected subsystems to determine which subsystem to optimize first including manual procedures for selecting the order of the subsystems for optimization, other automated approaches for ranking the subsystems and hybrid approaches combining both.

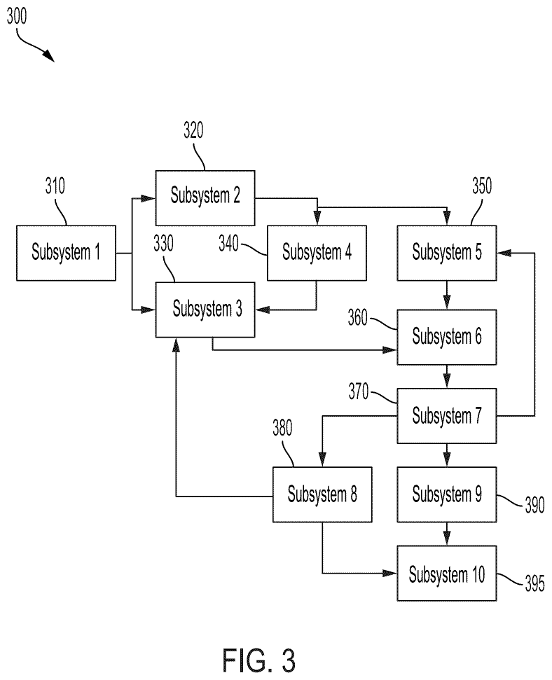

The structure of the complex system is leveraged and a ranking score for each subsystem is defined in order to decide which subsystem to optimize first based on designers/expert views to first divide the complex system into subsystems for initial optimization. A ranking score for each subsystem is such that the subsystem that has the most effect on other subsystems and least affected by other subsystems should have the highest rank, and hence, be optimized first. The interconnections between the subsystems (which subsystem affects other subsystems; the arrows in block diagram in FIG. 3) are leveraged by identifying the subsystem that has parameters affecting all other subsystems. The parameters of such a subsystem are set first, and only once, and then not touched afterwards so that the optimization of other subsystems is not repeated.

Ordering for Optimization of the Subsystems 120 produces Rankings 122 of the subsystems of a complex system of interconnected subsystems to determine which subsystem to optimize first including manual procedures for selecting the order of the subsystems for optimization, or other automated approaches for ranking the subsystems and hybrid approaches combining both. The ranking score for each subsystem is based on determining, as a subsystem having the highest rank, the subsystem that has the most effect on other subsystems and that is least affected by other subsystems. The highest-ranking subsystem is optimized first. This has the potential to eliminate/reduce the need for retuning this subsystem if parameters of other subsystems are changed.

To obtain the ranking scores, perturbation tests are performed in which one (and only one) subsystem output is changed at a time and its effect on other subsystems outputs is evaluated. Then, a score is defined to rank the subsystems such that the subsystem that has the most effect on other subsystems and is least affected by other subsystems receives the highest rank, and hence, is optimized first. That way, at least one embodiment systematically orders and optimizes the subsystems, and hence, minimizes/eliminates the need for retuning to some subsystems based on changes in other subsystems.

Screening is performed to define local regions of interest in the parameters space that demonstrate better performance than other regions. During screening, n regions with better performance than other tested regions are selected, e.g., the top n regions in terms of performance metric values. Screening is typically performed on a (typically small) subset of runs, I_screen⊂I, to provide a fast evaluation/hypothesis of regions that perform well.

For example, in at least one embodiment, the order of the subsystems for optimization are determined according to:
(a) Perturbation of the parameters or the output of one and only one subsystem (say subsystem i)
(b) Evaluation of each other subsystem j, j≠i, the change in the output of the subsystem due to the perturbation in subsystem i. Note that for time series outputs of subsystems, the accumulative absolute change from the output time series without the perturbation can also be evaluated.
(c) Normalization of the absolute change in the output of the subsystem j, j≠i, with respect to its output without perturbation to end up with a score between 0 and 1. The value 0 means that subsystem j is not affected by the changes in subsystem i, and the higher the value, the more effect a change to subsystem i has on subsystem j.

Steps (a)-(c) are repeated for each subsystem i.

A matrix of the mutual effects of subsystems on each other is constructed. The diagonal elements of the matrix are not of interest and are set to 1, while the off-diagonal element with index (i, j) indicates the mutual effect of subsystem i on subsystem j≠i. The value of index (i, j) is to be equal to the score calculated in step c. An example of matrix contents for a system of 3 interconnected subsystems is shown below for illustration:
[10.20.60.510.5001]
f) For each subsystem i, a score Si,1 is calculated to indicate accumulative effect of subsystem i on other subsystems by summing off-diagonal elements of row i in the matrix in (e). For example, the scores are S1,1=0.8, S2,1=1, S3,1=0.
g) For each subsystem i, a score Si,2 is calculated to indicate an accumulative effect of other subsystems on subsystem i by summing off-diagonal elements of column i in the matrix in (e). For example, the scores are S1,2=0.5, S2,2=0.2, S3,2=1.1.
h) Since the goal is to rank the subsystems such that the subsystem that has the most effect on other subsystems (highest Si,1) and least affected by other subsystems (lowest Si,2) should have the highest rank, then the accumulative score is defined to be Si=Si,1−Si,2. For example, the accumulative scores are S1=0.3,S2=0.8,S3,1=−1.1.
i) The subsystems are ranked in terms of their accumulative score Si from highest to lowest. The subsystems with higher rank should be optimized first. For example, subsystem 2 is to be optimized first, then subsystem 1, and finally subsystem 3.

At least one embodiment is not restricted to the above implementation but covers every implementation of a method that orders the optimization of the subsystems based on leveraging the structure of the interconnected systems and the mutual effects of the subsystems on each other. At least one embodiment provides a strategy for ordering the subsystems for optimization in order to systematically address the complexity challenge of system of interconnected.

Next, Optimal Parameter Setting of Each Subsystem 130 performs a local search to explore the parameter space of each subsystem. Optimal Parameter Setting of Each Subsystem 130 incorporates safety constraints for SIL specifications for parameter optimization to provide Optimal Settings of The Subsystems 132. In at least one embodiment, the local search finds optimal parameter values in each local region using machine-learning-based local optimization. A numerical, iterative-based optimization is performed starting from each identified local region above to find the best configuration in each local region. The “best configuration” is defined to be the one maximizing the defined performance metric for the system—the definition of the performance metric has inputs from the system designers/safety experts. The iterative optimization methods find the configuration parameters which maximize the defined performance metric. The iterative optimization method does that by evaluating a selected configuration and based on its output performance metric, decides what is the next configuration to test to move the solution towards the optimal configuration providing the maximum metric value. The local search is done on a vast majority of runs in I (e.g., 80% of runs) with the rest of the runs left over for the validation step (I_{leftover}⊂I).

The local search process of Optimal Parameter Setting of Each Subsystem 130 avoids the curse of dimensionality because the local search is applied on a lower-dimensional subsystem as compared to the original complex system of systems. The local search process of Optimal Parameter Setting of Each Subsystem 130 also combines the merits of sampling approaches and iterative machine-learning-based local optimization methods, and is designed to allow simultaneous, multiple local searches so that the local search is easily parallelized on parallel computing processors allowing for optimizing complex subfunctions. The local search process of Optimal Parameter Setting of Each Subsystem 130 also evaluates and provides the sensitivity of each subsystem output with respect to each configuration parameter of the subsystem and ranks parameters in terms of their effect on the output. The ranking order of the subsystem is used to find the optimal setting of the system of systems.

Find Optimal Parameter Setting of The Overall System of Systems 140 starts from the Optimal Settings of The Subsystems 132 obtained above and tweaks/adjusts high-sensitivity parameters, e.g., parameters having the most dominant effects on the subsystems outputs, until further improvement of the overall system performance metric is insignificant, or target user-defined performance is met. Tweak/adjustments refers to allowing the optimization algorithm to change the values of parameters but within a constrained range. For example, in response to the optimal configuration of a parameter being found in local search to be 1.5, then the value of the parameter is adjusted in the overall optimization of system of systems in response to being decided to be a high-sensitivity parameter, i.e., has a significant effect on performance metric value. As an example, the parameter is changed only within +/−0.1 constraints, i.e., a search for the best value between 1.4, 1.6 for maximizing the overall performance metric of system of systems What is insignificant or a target user-defined performance are application/system dependent. An example of improvement of overall performance metric which is insignificant increases output accuracy metric by 0.001%/ An example of target user-defined performance metric being met involves an error in the system output that less than 0.1% of output value, and a probability of output value exceeding a hazardous limit is less than defined tolerable hazard rate (THR) (10⁻⁹ failure per hour), and probability of system shutdown/non-availability is less than desired target non-availability rate of 10⁻⁵.

Overall Optimal Parameter Settings 142 are determined by comparing the Optimal Settings of The Subsystems 132. The Optimal Parameter Setting of the Overall System of Systems 142 reflects the multiple objectives of the design of the system including low output errors, safe system operation and high system availability, among others.

The Optimal Parameter Setting of each Subsystem 132 obtained above is used to search for the Optimal Parameter Setting of The Overall System of Systems 140. Since it is not feasible to optimize all the 100+ parameters of system of systems all at once due to the curse of dimensionality as stated above, the strategy reaches the overall optimal solution incrementally by tweaking first highest-sensitivity-rank parameters that have the most effect on outputs of the subsystems according to sensitivity analysis above, and then tweaking the second-highest-sensitivity-rank parameters, and so on, until further improvement in the performance metric of the system of systems resulting from tweaking the parameters become insignificant or when user-defined target performance has been reached.

Tweaking a set of parameters for optimizing a defined performance matrix (in any of the incremental steps toward the optimal solution above) is able to be accomplished by running a numerical, iterative-based optimization method (e.g., ParamILS or SMAC). Also, validation of the found global optimum parameter setting of system of systems needs to be carried out as a final step for ensuring generalization of the found solution as indicated above. Indeed, there are different methods for incremental tweaking of key (high sensitivity) parameters to reach the global optimum parameter setting of system of systems.

Validation of the Optimal Parameter Setting on Leftover Sample Data set 150 performs validation and provides Validation Information 152 to ensure generalization of the found solution. After we calculate the optimal configuration of parameters of system of systems and its optimal performance metric value are calculated, validation is simply done by: 1. running the system of systems with found optimal configuration of parameters on the left-over sample data (leftover data not used in the previous optimization steps), and 2. calculating the performance metric on the leftover sample data, and 3. Verify that the performance metric value found on the leftover sample data is within a threshold (in the same order of magnitude) of the performance metric value for the sample data used for optimization.

Validation 150 of found optimal setting is applied to a subset of sample data not used before in parameter optimization (to avoid overfitting). The optimal parameter configuration for the subsystem is validated against another subset of the run list I, namely I_{leftover}⊂I not used in the last three steps in tuning. This ensures that the found optimal solution generalizes well beyond the optimization data set and there is no issue of overfitting.

Also, the one or more embodiments provide a method for incorporating the safety requirements of high-integrity systems into the optimization problem by evaluating a probability of failure or failure rate per hour for a residual risk/edge case scenario from the data, and heavily penalizing the metric value/score of the configurations that do not meet the tolerable hazard rate (THR) level for the desired SIL (e.g., SIL4). The higher the SIL level, the higher the associated safety level, and the lower probability that a system will fail to perform properly. SIL 4 is associated with a probability of dangerous failure per hour (PFH) of 10⁻⁸ to 10⁻⁹ for continuous operation. A safety constraint is not added only in the validation step but is added as part of the optimization metric and hence it is accounted for in all the optimization steps. A heavy penalty is then applied to the performance metric for optimization of any configuration that does not meet the target failure rate per hour for the desired Safety Integrity Level (SIL), such as SIL4.

Embodiments described herein do not require building statistical models of each system's variable but does respect the time correlation aspect of complex dynamic systems. In particular, at least one embodiment relies on using the sample data for optimization of augmented data (of Field Data 111/Synthetic Data 117) including edge case scenarios of interest from the Safety Analysis 114 (e.g., injected failure scenarios defined from FMEA, FTA, STPA, HAZOP, and that cannot be closed using only qualitative analysis). Next, the sample data defined pass/fail criteria is evaluated for each failure scenario of interest. An empirical statistical approach (e.g., block bootstrapping) is used to define a probability of failure for each configuration choice based on the evaluation results. The probability of failure is then converted to failure rate per hour, and configuration choice is rejected/highly penalized if a combined failure rate per hour for the defined failure scenarios does not meet the target failure rate per hour needed for SIL4 systems.

Parameter Setting on Leftover Sample Data set 150 is considered from beginning of optimization problem in the selection of the optimization metric, and only in the validation step and not using leftover data only. The optimization problem is adapted to penalize heavily any configuration not meeting the safety constraints. The probability of failure under the residual risk scenario is evaluated. While the naïve approach is to calculate the probability of failure as:

Number of executation cycles with “Fail” tag/Total number of executation cycles in the evaluation’
the naïve method is not appropriate as the naïve approach provides only information on the mean value of the probability of failure, and there is no confidence interval provided (i.e., upper bound on probability of failure remains unknown). Also, the naïve method assumes independence between observations (each pass/fail result for each execution cycle), but this assumption is not always valid because, for dynamic systems, the pass/fail at one execution cycle is typically correlated with the pass/fail result of a previous execution cycle.

Instead, the probability of failure distribution is modeled to provide an upper bound on the probability. In general, this can be very challenging. Hence, in one or more embodiments, empirical statistical methods, e.g., bootstrapping, are used to estimate an upper bound on the probability of failure for a required confidence level.

Empirical statistical methods, e.g., bootstrapping methods, use samples to draw inferences about unknown populations and without imposing a priori assumptions on the populations. In particular, the empirical statistical methods take the sample data and then resample it over and over randomly with replacement to create simulated samples (called bootstrap samples). For each of the samples, the mean is able to be calculated using the naïve approach as described above. By graphing the distribution of the mean values of the probability of failure on a histogram, the sampling distribution of the mean of the probability of failure is able to be observed. The sampling distribution/histogram of the mean is also able to be used to determine a confidence interval of the probability of failure. The idea is that by having large number of bootstrap samples, the central limit theorem ensures having a symmetrical normal distribution of the mean histogram regardless the distribution of the population we sample from. The number of standard deviations corresponding to a required confidence level (e.g., multiple of 5 for 0.9999994 confidence level) is able to be selected, and then this multiple of standard deviations is used to find the upper bound on the probability of failure. To solve the second challenge of the naïve approach (time correlation/dependency between consecutive execution samples for dynamic systems), one or more embodiments uses a version of bootstrapping methods that can handle time correlation, e.g., block bootstrapping. However, any empirical statistical method is able to be used to calculate probability of failure or the failure rate per hour from sample data.

Block bootstrapping is able to handle correlated data by resampling blocks of data with replacement instead of resampling individual observations with replacement. Consecutive samples of one evaluation/simulation of synthetic data are to be kept in one block, so that data inside each block are correlated but blocks themselves are independent so that the assumption in bootstrapping of resampling with replacement from independent identities/units is satisfied.

After calculating an upper bound on the probability of system failure for each residual risk scenario identified in the qualitative safety analysis, these probabilities are able to be combined to provide overall probability of failure and then converted to failure rate per hour. Assuming the completeness of the qualitative safety analysis, and hence, the set of identified residual risk scenarios E₁, E₂, . . . , E_{N}, then the probability of failure is P(F)=P(F∩E₁∪ . . . ∪E_{N}))=P((F∩E₁)∪ . . . ∪(F∩E_{N})). Then, from the laws of probability, the probability of the union of events is always less than or equal to the summation of the probabilities of the events, and hence, P(F)≤P(F∩E₁)+ . . . +P(F∩E_{N}). Each term in the right-hand side of the last equation is able to be characterized as above based on synthetic data evaluations and empirical statistics methods (e.g., block bootstrapping). The probability of failure P(F) is then converted to failure rate per hour and compared to desired Tolerable Hazard Rate (THR) for a desired SIL integrity level.

For each configuration of parameters under test, there is either a successful check, i.e., the calculated failure rate per hour is equal to/below the desired THR level, or a failed check, i.e., the calculated failure rate per hour exceeds the desired THR level. A high (positive) penalty term is added to the metric value for the configuration of parameters that has failed a check, i.e., any configuration that does not meet the safety requirement for the desired safety integrity level is heavily penalized.

Accordingly, at least one embodiment breaks down the complexity of high-dimensional system by leveraging the coupling structure of its interconnected subsystems and provides a systematic methodology for incorporating safety SIL constraints into the optimization problem, including automatically finding data and/or incorporating synthetic data of edge case scenarios of importance for safety. Probability of failure (and hence failure rate per hour) of residual risk edge case scenarios of interest are evaluated, and the optimization problem is adapted to penalize heavily any configuration not meeting the safety constraints. This is a differentiator of the embodiments described herein from other approaches on parameter optimization. At least one embodiment described herein is generic enough to be applied to any system of interconnected subsystems, and it is not tied to a particular module type as in most of the existing parameter optimization methods as described above. Further, the automated framework 100 selects a representative sample data set for optimization. Thus, at least one embodiment described herein saves a huge amount of manual trial-and-error efforts, and hence, saves time and money. Knowledge of experts, design & safety analysis artifacts, and automated data analytics are combined to define a representative sample data set for optimization including various operational/environmental conditions and edge case scenarios. This ensures the generalization of the found optimal solution, i.e., the optimal solution is not overfitting a particular scenario found in a limited data set. This resolves a key shortcoming of manual tuning, which is typically carried out on a limited amount of data.

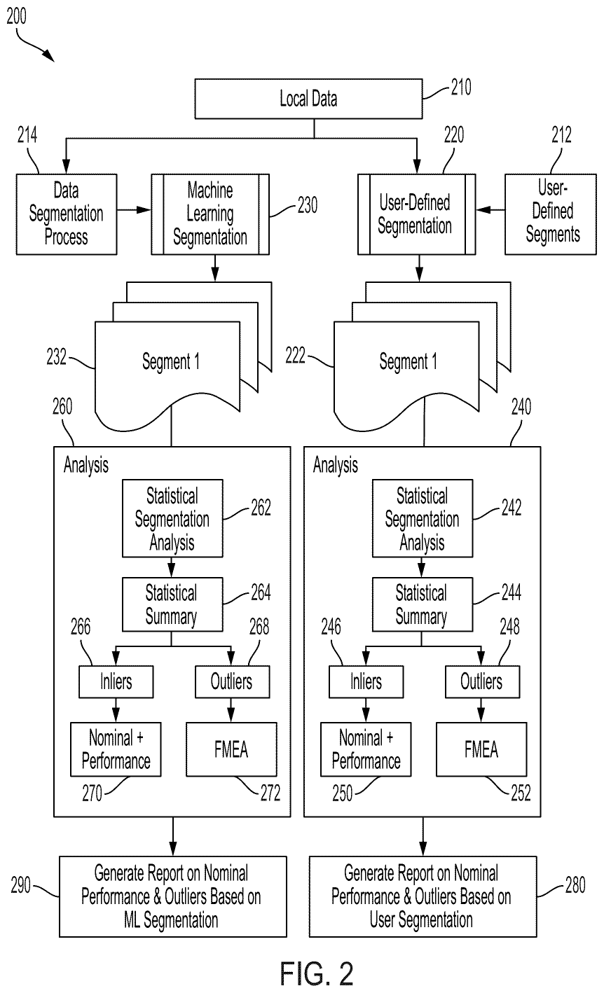

FIG. 2 illustrates hybrid representative sample data set development 200 for parameter optimization according to at least one embodiment.

In FIG. 2, the hybrid representative sample data set development 200 relies on using data analytics to define a representative sample data set.

A Local Data set 210 is provided to User Defined Segmentation 220 and to Data Segmentation Process 214. Data Segmentation Process 214 provides the Local Data 210 to unsupervised, Machine Learning (ML) Segmentation 230. User Defined Segments 212 are identified for User Defined Segmentation 220. Local Data set 210 includes collected field data of the system as well as synthetic data of edge case scenarios defined in the safety analysis of the system (e.g., FTA, FMEA, STPA, HAZOP). The unsupervised ML Segmentation 230 is meant to complement the experts' knowledge by finding interesting features in the data set overlooked by the designers. Examples of feature extraction techniques used by User Defined Segmentation 220 and Machine Learning (ML) Segmentation 230 are Principal Component Analysis (PCA), multi-dimensional scaling (MDS) and autoencoders, among others. Then, for either designer or unsupervised approach, clustering approaches are able to be applied to further classify the data of each segment into similar clusters. Examples of clustering approaches include, but are not limited to, K-means, Dynamic Time Wrapping (DTW) K-means, and Density-Based Spatial Clustering of Applications with Noise (DBSCAN). Nevertheless, one or more embodiments include other ways of segmentation of data using experts' knowledge together with automated data analytics methods.

Segments 222, 232 are then provided per segment to Analysis 240, 260, respectively. A hybrid data analytics approach via Analysis 240, 260 is applied to the augmented data set (of field data and synthetic data) to efficiently define the representative sample data set. Statistical Segmentation Analysis 242, 262 is carried out for each segment or cluster, which can include, but is not limited to, nominal cluster identification, trend detection, anomaly detection, variables correlation determination, among others. A Statistical Summary 244, 264 is then produced.

Next, sampling is carried out to include in the sample data set (i) data of each defined segmentation of data by either designers or machine learning approaches, (ii) data of nominal behavior (nominal clusters), (iii) data of different trends, (iv) data of anomalous behaviors. The data can also be balanced to ensure that no certain segmentation/cluster is overrepresented in the sample data set. Inliers 246, 266 and Outliers 248, 268 in the Statistical Summary 244, 264 are identified. An inlier is an erroneous data value which actually lies in the interior of a statistical distribution, making it difficult to distinguish from good data values. An outlier is a data value that lies in the tail of the statistical distribution of a set of data values. In the distribution of raw data, outliers are often regarded as more likely to be incorrect. Inliers 246, 266 are analyzed to determine nominal performance 250, 270 and failure analysis, e.g., FMEA 252, 272 is applied to Outliers 248, 268.

Reports 280, 290 are generated on nominal performance and outliers based on User Segmentation 220 and ML Segmentation 230, respectively. The representative sample data set includes all the defined operational & environmental conditions of interest to the designers, trends automatically defined by unsupervised ML approaches, which may have been overlooked by the designers, data of nominal and anomalous behaviours, and data of potential edge cases for safety.

The complexity of high-dimensional system of interconnected subsystems is broken down to handle complex, high-dimensional system of interconnected subsystems. This is because optimizing the overall high-dimensional system all at once may not be feasible given the well-known curse of dimensionality problem (exponential growth of computational time/resources with the number of parameters). For example, for a system with 100+ parameters, exploring only two candidate values (low and high values) for each parameter would result in 2¹⁰⁰=1.2676506*10³⁰ parameter configurations to test, which is not feasible. Hence, the optimization framework leverages the structure of the complex system of interconnected subsystems and optimizes parameters incrementally starting from optimizing the subsystems first.

Given a system of interconnected subsystems, a question arises of how the optimization of those subsystems is ordered to minimize the efforts of retuning some subsystems when other subsystems are changed. One or more embodiments rank the subsystems for optimization. The ranking score for each subsystem is such that the subsystem that has the most effect on other subsystems and least affected by other subsystems should have the highest rank, and hence, be optimized first. That way, retuning the subsystem when other subsystems are optimized/tuned is eliminated or minimized. Note that the order of optimizing the subsystems is not easy to determine, especially for complex systems with multiple feedback signals among the subsystems.

FIG. 3 illustrates a complex system of interconnected subsystems 300 according to at least one embodiment.

In FIG. 3, Subsystem 1 310 provides input to Subsystem 2 320 and Subsystem 3 330. Subsystem 2 320 provides input to Subsystem 4 340 and System 5 350. Subsystem 4 340 provides feedback to Subsystem 3 330. Subsystem 5 350 provides input to Subsystem 6 360.

Subsystem 3 330 provides input to Subsystem 6 360. Subsystem 6 360 receives input from Subsystem 3 330 and Subsystem 5 350. Subsystem 6 360 provides input to Subsystem 7 370. Subsystem 7 370 provides feedback to Subsystem 5 350 and provides input to Subsystem 8 380 and Subsystem 9 390.

Subsystem 8 380 provides feedback to Subsystem 3 330 and provides input to Subsystem 10 395. Subsystem 9 390 receives input from Subsystem 7 370 and provides input to Subsystem 10 395. Subsystem 10 395 receives input from Subsystem 8 380 and Subsystem 9 390.

As described above, to determine the order of the subsystems for optimization, a three-step process is used. In step (a), the parameters or the output of one and only one subsystem (say subsystem i) is perturbed.

In step (b), for each other subsystem j, j≠i, the change in the output of the subsystem due to the perturbation in subsystem i is evaluated. Note that for time series outputs of subsystems, the accumulative absolute change from the output time series without the perturbation can also be evaluated.

In step (c), the absolute change in the output of the subsystem j, j≠i, with respect to its output without perturbation is normalized to end up with a score between 0 and 1. The value 0 means that subsystem j is not affected by the changes in subsystem i, and the higher the value, the more effect subsystem i has on subsystem j.

Steps (a)-(c) are repeated for each subsystem i.

A matrix of the mutual effects of subsystems on each other is constructed. The diagonal elements of the matrix are not of interest, and they should be set to 1, while the off-diagonal element with index (i, j) indicates the mutual effect of subsystem i on subsystem j≠i. The value of index (i, j) should be equal to the score calculated in step c. (Toy) example of matrix contents for a system of 3 interconnected subsystems is shown below for illustration:

$$[ \begin{matrix}1 & 0.2 & 0.6 \\ 0.5 & 1 & 0.5 \\ 0 & 0 & 1\end{matrix} ]$$

For each subsystem i, a score S_{i,1} indicating accumulative effect of subsystem i on other subsystems is calculated by summing off-diagonal elements of row i in the matrix. For the considered toy example, the scores are S_{1,1}=0.8 (calculated as S_{1,2}+S_{1,3}), S_{2,1}=1 (calculated as S_{2,1}+S_{2,3}), S_{3,1}=0 (calculated as S_{3,1}+S_{3,2}).

For each subsystem i, a score S_{i,2} indicating accumulative effect of other subsystems on subsystem i is calculated by summing off-diagonal elements of column i in the matrix. For the considered toy example, the scores are S_{1,2}=0.5 (calculated as S_{2,1}+S_{3,1}), S_{2,2}=0.2 (calculated as S_{1,2}+S_{3,2}), S_{3,2}=1.1 (calculated as S_{1,3}+S_{2,3}).

Since the goal is to rank the subsystems such that the subsystem that has the most effect on other subsystems (highest S_{i,1}) and least affected by other subsystems (lowest S_{i,2}) should have the highest rank, then the accumulative score is defined to be Sᵢ=S_{i,1}−S_{i,2}. For the considered toy example, the accumulative scores are S₁=0.3 (calculated as S_{1,1}−S_{1,2}), S₂=0.8 (calculated as S_{2,1}−S_{2,2}), and S_{3,1}=−1.1 (calculated as S_{3,1}−S_{3,2}).

The subsystems are ranked in terms of their accumulative score Sᵢ from highest to lowest. The subsystems with higher rank should be optimized first. For the considered toy example, subsystem 2 should be optimized first, then subsystem 1, and finally subsystem 3.

One or more embodiments are not restricted to the above implementation method and cover every implementation of a method that orders the optimization of the subsystems based on leveraging the structure of the interconnected subsystems and the mutual effects of the subsystems on each other. The subsystems are thus optimized in order to systematically address the complexity challenge of system of interconnected subsystems. The parameter space of each subsystem is explored to find an optimal parameter setting of the subsystem.

For each subsystem the following are defined: (1) parameter space defining feasible parameter ranges and/or distributions for each parameter, denoted C, which can be extracted automatically from design documentations or system parameter list, (2) performance metric function, denoted m, defined by the system designers to reflect the multiple objectives of the design of the subsystem, including low output errors, safe subsystem operation and high subsystem availability, among others, and (3) representative sample data set defined by a set of runs of the subsystem, denoted I, identified by the novel hybrid strategy in (1). The optimal configuration for the subsystem, denoted c*∈C, which optimizes the performance of the subsystem on the set of subsystem runs/according to metric m is determined.

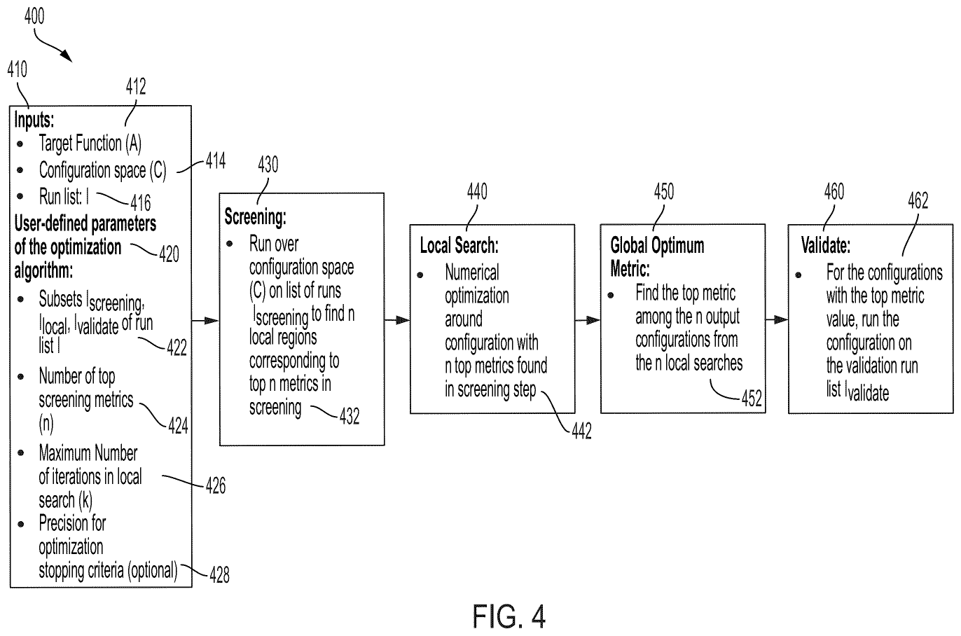

FIG. 4 defines a method 400 for efficiently optimizing the parameters of each subsystem according to at least one embodiment.

FIG. 4 shows Inputs 410 and User-Defined Parameters of the Optimization Algorithm 420 are provided. Inputs 410 include Target Function (A) 412, Configuration Space (C) 414, Run List (I) 416, Metric (m) 418, and the like. User-Defined Parameters of the Optimization Algorithm 420 include Subsets I_{screen}, I_{local}, I_{validate} of run list I 422, Number of top screening metric values (n) 424, Maximum number of iterations in local search (k) 426, Precision for optimization stopping criteria (optional) 428, and the like. Method 400 is able to be applied to any complex system of interconnected subsystems, i.e., it is not tied to a particular component/system type as in the vast majority of other methods. Indeed, the interconnected subsystems are able to include, but are not limited to, sensor interfaces, filters, estimators, controllers, supervisions, alarms, artificial intelligence components.

Screening 430 is run over a configuration space (C) on a list of runs, I_{screen}, to find n local regions corresponding to top n metrics in screening 432 to define in the parameters space local regions of interest with promising performance. This is typically performed on a (typically small) subset of runs, I_{screen}⊂I to have a fast evaluation/hypothesis of regions, which performs well.

A Local Search 440 is performed to run a numerical, iterative-based optimization approach starting from each identified local region above 442 to find the best configuration in each local region. The local search is performed on a vast majority of runs in I (e.g., 80% of runs) with the rest of the runs left over for the validation step (I_{leftover}⊂I).

Global Optimum Metric 450 compares the local optimum values identified in the previous step 452 to determine the global optimal value.

Validation 460 is performed to validate the optimal parameter configuration for the subsystem against another subset of the run list I 462, namely I_{leftover}⊂I not used in the last three steps in tuning. This ensures that the determined optimal solution generalizes well beyond the optimization data set and there is no issue of overfitting.

As part of the Screening 430, sensitivity analysis of the effects of individual parameters is performed. In particular, sensitivity analysis is performed by changing only one parameter at a time and evaluating the change in the subsystem output due to that parameter change. The automated strategy can also rank the parameters in terms of their effect on the subsystem output from highest to lowest. This ranking will be useful in the next step in efficiently tweaking the most important (highest rank) parameters for finding the optimal configuration of system of interconnected subsystems. This is because tweaking/changing all parameters of the system of interconnected subsystems is not feasible from a computational perspective due to the well-known curse of dimensionality issue. Sensitivity analysis and ranking of parameters effect also provide interpretability of the parameters effects to designers and tests which is key for certification of safety-critical systems.

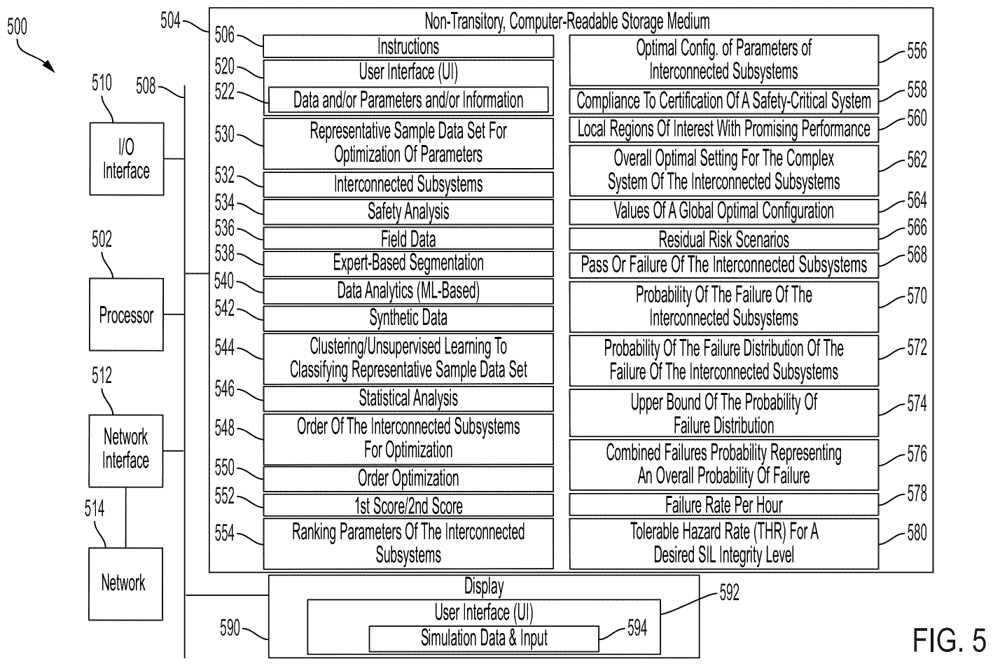

FIG. 5 is a block diagram of a processing system 500 in accordance with some embodiments.

In at least one embodiment, processing circuitry 500 provides an automatic optimization framework for safety-critical systems of interconnected subsystems. Processing circuitry 500 implements the automatic optimization framework for safety-critical systems of interconnected subsystems using Processor 502. Processing circuitry 500 also includes a Non-Transitory, Computer-Readable Storage Medium 504 that is used to implement the automatic optimization framework for safety-critical systems of interconnected subsystems. Non-Transitory, Computer-Readable Storage Medium 504, amongst other things, is encoded with, i.e., stores, Instructions 506, i.e., computer program code, that are executed by Processor 502 causes Processor 502 to perform operations for providing the automatic optimization framework for safety-critical systems of interconnected subsystems. Execution of Instructions 506 by Processor 502 represents (at least in part) an application which implements at least a portion of the methods described herein in accordance with one or more embodiments (hereinafter, the noted processes and/or methods).

Processor 502 is electrically coupled to Non-Transitory, Computer-Readable Storage Medium 504 via a Bus 508. Processor 502 is electrically coupled to an Input/Output (I/O) Interface 510 by Bus 508. A Network Interface 512 is also electrically connected to Processor 502 via Bus 508. Network Interface 512 is connected to a Network 514, so that Processor 502 and Non-Transitory, Computer-Readable Storage Medium 504 connect to external elements via Network 514. Processor 502 is configured to execute Instructions 506 encoded in Non-Transitory, Computer-Readable Storage Medium 504 to cause processing circuitry 500 to be usable for performing at least a portion of the processes and/or methods. In one or more embodiments, Processor 502 is a Central Processing Unit (CPU), a multi-processor, a distributed processing system, an Application Specific Integrated Circuit (ASIC), and/or a suitable processing unit.

Processing circuitry 500 includes I/O Interface 510. I/O interface 510 is coupled to external circuitry. In one or more embodiments, I/O Interface 510 includes a keyboard, keypad, mouse, trackball, trackpad, touchscreen, and/or cursor direction keys for communicating information and commands to Processor 502.

Processing circuitry 500 also includes Network Interface 512 coupled to Processor 502. Network Interface 512 allows processing circuitry 500 to communicate with Network 514, to which one or more other computer systems are connected. Network Interface 512 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 500 is configured to receive information through I/O Interface 510. The information received through I/O Interface 510 includes one or more of instructions, data, design rules, libraries, and/or other parameters for processing by Processor 502. The information is transferred to Processor 502 via Bus 508. Processing circuitry 500 is configured to receive information related to a User Interface (UI) 520 through I/O Interface 510. The information is stored in Non-Transitory, Computer-Readable Storage Medium 504 as UI 520, wherein UI 520 presents Data and/or Parameters and/or Information 522.

In one or more embodiments, one or more Non-Transitory, Computer-Readable Storage Medium 504 having stored thereon Instructions 506 (in compressed or uncompressed form) that may be used to program a computer, processor, or other electronic device) to perform processes or methods described herein. The one or more Non-Transitory, Computer-Readable Storage Medium 504 include one or more of an electronic storage medium, a magnetic storage medium, an optical storage medium, a quantum storage medium, or the like.

For example, the Non-Transitory, Computer-Readable Storage Medium 504 may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more Non-Transitory Computer-Readable Storage Media 504 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 504 stores Instructions 506 configured to cause Processor 502 to perform at least a portion of the processes and/or methods for the automatic optimization framework for safety-critical systems of interconnected subsystems. In one or more embodiments, Non-Transitory, Computer-Readable Storage Medium 504 also stores information, such as algorithm which facilitates performing at least a portion of the processes and/or methods for the automatic optimization framework for safety-critical systems of interconnected subsystems.

Accordingly, in at least one embodiment, Processor 502 executes Instructions 506 stored on the one or more Non-Transitory, Computer-Readable Storage Medium 504 to produce a Representative Sample Data Set for Optimization of Parameters 530. Processor 502 identifies Interconnected Subsystems 532 for generating the Representative Sample Data Set for Optimization of Parameters 530. Processor 502 implements Safety Analysis 534 to incorporate synthetic failure injection in Field Data 536 to provide augmented data including edge case scenarios. Safety Analysis 534 injects failure scenarios, e.g., defined from Failure Mode and Effect Analysis (FMEA), Fault-Tree Analysis (FTA), System-Theoretic Process Analysis (STPA), Hazard and Operability (HAZOP), and that cannot be closed using only qualitative analysis, to generate Synthetic Data 542. Processor 502 implements Expert-Based Segmentation 538 and Data Analytics (ML-Based) 540. Processor 502 generates Synthetic Data 542 for all the edge case scenarios (identified in the Safety Analysis 534) as part of the Representative Sample Data Set for Optimization of Parameters 530. Processor 502 generates Synthetic Data 542 based on input from Data Analytics (ML-Based) 540 and from Safety Analysis 534. The Representative Sample Data Set for Optimization of Parameters 530 is selected based on the Synthetic Data 542 and input from Expert-Based Segmentation 538 and Data Analytics (ML-Based) 540. The Representative Sample Data Set for Optimization of Parameters 530 is selected by applying Clustering/Unsupervised Learning To Classifying Representative Sample Data Set 544 to further classify the Representative Sample Data Set 530 into groups according to similarities in the Representative Sample Data Set 530, and by performing Statistical Analysis 546 for each of the groups. Processor 502 determines an Order Of The Interconnected Subsystems For Optimization 548 by determining a First Score and a Second Score 552, wherein the First Score indicates a cumulative effect of a first of the interconnected subsystems on other subsystems, and the second score indicates a cumulative effect of the other of the interconnected subsystems on the first of the interconnected subsystems. Processor determines Order Optimization 550 based on the First Score indicating the first interconnected subsystem that has the most effect on the other of the interconnected subsystems in response to the change in the parameters of the first of the interconnected subsystems and the Second Score indicating the first interconnected subsystem that is least affected by the other of the interconnected subsystems in response to the cumulative change in the parameters of the other of the interconnected subsystems, or based on a combination of the First Score and the Second Score 546. Processor uses the Order Of The Interconnected Subsystems For Optimization 548 to determine which subsystem to optimize first. Processor 502 leverages the structure of the complex system to define Ranking Parameters Of The Interconnected Subsystems 554, wherein a ranking score for each subsystem is used to decide which subsystem to optimize first. Processor 502 determines the ranking score for each subsystem based on determining, as a subsystem having the highest rank, the subsystem that has the most effect on other subsystems and that is least affected by other subsystems. Processor 502 performs a local search to explore the parameter space of each subsystem. Processor 502 uses the local search to find Optimal Configuration Of The Parameters Of The Interconnected Subsystems 556 in each local region using machine-learning-based local optimization. Processor 502 is able to use a numerical, iterative-based optimization that starts from each identified Local Regions Of Interest With Promising Performance 560 to find the best configuration in each local region. Processor 502 tweaks/adjusts high-sensitivity parameters, e.g., parameters having the most dominant effects on the subsystems outputs, until further improvement of the overall system performance metric is insignificant, or target user-defined performance is met. Processor 502 determines Overall Optimal Setting For The Complex System Of The Interconnected Subsystems 562 by comparing the Optimal Configuration Of The Parameters Of The Interconnected Subsystems 556 in each local region. Overall Optimal Setting For The Complex System Of The Interconnected Subsystems 562 reflects the multiple objectives of the design of the system including low output errors, safe system operation and high system availability, among others. Processor 502 compares the local Optimal Configuration Of The Parameters Of The Interconnected Subsystems 556 to determine Values Of A Global Optimal Configuration 564. Processor 502 incorporates Compliance To Certification Of A Safety-Critical System 558 in the Overall Optimal Setting For The Complex System Of The Interconnected Subsystems 562. Processor 502 incorporates Compliance To Certification Of A Safety-Critical System 558 by performing Safety Analysis 534 of the Interconnected Subsystems 532 and defining Residual Risk Scenarios 566 based on the Safety Analysis 534. Processor 502 generates Synthetic Data 542 for the Residual Risk Scenarios 566. For each of the Residual Risk Scenarios 566, Processor 502 evaluates the output of the Interconnected Subsystems 532 to determine Pass Or Failure Of The Interconnected Subsystems 568. Processor 502 determines a Probability Of The Failure Of The Interconnected Subsystems 570 under the Residual Risk Scenarios 566 based on the Pass Or Failure Of The Interconnected Subsystems 568. Processor 502 models a Probability Of Failure Distribution Of The Failure Of The Interconnected Subsystems 572 under the Residual Risk Scenarios 566 and determines an Upper Bound Of The Probability Of Failure Distribution 574 under the Residual Risk Scenarios 566. Based on the Upper Bound Of The Probability Of Failure Distribution 574, Processor 502 combines Probability Of The Failure Of The Interconnected Subsystems 570 to provide a Combined Failures Probability Representing An Overall Probability Of Failure 576. Processor 502 converts the Combined Failures Probability Representing An Overall Probability Of Failure 576 to a Failure Rate Per Hour 578. Processor 502 compares the Failure Rate Per Hour 578 to a Tolerable Hazard Rate (THR) For A Desired SIL Integrity Level 580. Processor identifies a success or failure for the parameters of the Interconnected Subsystems 532 based on the comparison of the Failure Rate Per Hour 578 to the Tolerable Hazard Rate (THR) For A Desired SIL Integrity Level 580. Processor 502 uses Display 590 to present a User Interface (UI) 592. UI 592 enables a user to select and view Simulation Data 594.

Accordingly, one or more embodiments described herein provide an overall approach/strategy of optimizing parameter values of complex, high-dimensional, safety-critical system of interconnected subsystems. Unlike existing approaches, one or more embodiments described herein are scalable to high-dimensional systems of systems by leverage the coupling structure of the complex system of interconnected subsystems instead of optimizing the parameters of the overall system all at once, and applying efficient approaches for determining a best efficient coverage of the parameter space of the subsystems and for finding the Optimal Parameter Setting of the Overall System of Systems 142 by adjusting/tweaking only high-sensitivity parameters. That way, the one or more embodiments do not suffer from the curse of dimensionality issue in existing approaches, and it can be efficiently applied to optimize high-dimensional systems of systems with 100+ parameters.

Referring again to FIG. 1, the automated framework 100 according to at least one embodiment, unlike existing approaches, is designed for safety-critical systems. In particular, at least one embodiment includes a systematic approach for incorporating Synthetic Data of Edge Case Scenarios 116 from Safety Analysis 114, and for evaluating for each configuration choice whether SIL requirements of safety-critical systems (particularly, on failure rate per hour) are met. Configurations that do not meet the safety requirements are rejected or their metric value is heavily penalized so that they are not selected by the optimization algorithm. One or more embodiments can be applied to any system of interconnected subsystems, and it is not restricted to particular system or machine learning module type as in the existing approaches. This includes, but is not limited to, optimizing the parameters of sensor interfaces, signal preprocessing components, filters, estimators, controllers, AI components, supervisions, alarms, and the like. One or more embodiments systematically select representative sample data set for parameter optimization using a hybrid approach in order to ensure that all operational & environmental conditions of interest, including Synthetic Data 117 generated from edge case scenarios from Safety Analysis 114, are considered. The one or more embodiments also incorporate a Validation 150 sub-step on data not used in the parameter optimization approach. Hence, the approach according to at least one embodiment is less prone to overfitting as compared to manual tuning or other automated approaches that have not specified how to make the sample data covering possible scenarios including edge cases.

One or more embodiments eliminate huge amounts of manual trial-and-error work, which results in saving effort, time, and money as well as reaching the optimal setting in a systematic manner that can be easily justified to safety audits in the certification process of the safety-critical system.

As described above with reference to FIG. 1, the one or more embodiments include a framework for identification of representative sample data set for parameter optimization 110, a strategy for breaking down the complexity of high-dimensional system of interconnected subsystems 120, an efficient approach for exploring the parameter space of each subsystem for optimizing its parameters 130, an approach for finding the optimal parameter setting for the overall system of interconnected subsystems starting from the optimal parameter values obtained for the subsystems 140, and an approach for incorporating compliance to safety requirements of SIL4 system in the automatic parameter optimization framework 150.

In at least one embodiment, a method for automatically optimizing the parameters of a safety-critical system of interconnected subsystems includes selecting a representative sample data set for optimization of parameters of interconnected subsystems of a complex system using a hybrid data analytics approach, breaking down a complexity of optimizing the complex system into interconnected subsystems by determining an order of the interconnected subsystems for optimization, based on the order of the interconnected subsystems, exploring a parameter space of each of the interconnected subsystems to define an optimal configuration of the parameters of the interconnected subsystems for optimizing performance of the interconnected subsystems, determining an overall optimal setting for the complex system of the interconnected subsystems based on the an optimal configuration of the parameters of the interconnected subsystems and incorporating compliance to certification of a safety-critical system in the overall optimal setting for the complex system.

In at least one embodiment, an apparatus for providing automated optimization for safety-critical system of interconnected subsystems includes a memory storing computer-readable instructions, and a processor connected to the memory, wherein the processor is configured to execute the computer-readable instructions to select a representative sample data set for optimization of parameters of interconnected subsystems of a complex system using a hybrid data analytics approach, break down a complexity of optimizing the complex system into interconnected subsystems by determining an order of the interconnected subsystems for optimization, based on the order of the interconnected subsystems, explore a parameter space of each of the interconnected subsystems to define an optimal configuration of the parameters of the interconnected subsystems for optimizing performance of the interconnected subsystems, determine an overall optimal setting for the complex system of the interconnected subsystems based on the an optimal configuration of the parameters of the interconnected subsystems, and incorporate compliance to certification of a safety-critical system in the overall optimal setting for the complex system.

In at least one embodiment, a non-transitory computer-readable media having computer-readable instructions stored thereon, which when executed by a processor causes the processor to perform operations including selecting a representative sample data set for optimization of parameters of interconnected subsystems of a complex system using a hybrid data analytics approach, breaking down a complexity of optimizing the complex system into interconnected subsystems by determining an order of the interconnected subsystems for optimization, based on the order of the interconnected subsystems, exploring a parameter space of each of the interconnected subsystems to define an optimal configuration of the parameters of the interconnected subsystems for optimizing performance of the interconnected subsystems, determining an overall optimal setting for the complex system of the interconnected subsystems based on the an optimal configuration of the parameters of the interconnected subsystems, and incorporating compliance to certification of a safety-critical system in the overall optimal setting for the complex system.

Embodiments described herein provide a novel framework for automatically optimizing the parameters of complex, safety-critical system of interconnected subsystems. The foregoing outlines features of embodiments described herein so that those skilled in the art may better understand the aspects of the embodiments. Those skilled in the art appreciate that the embodiments described herein are able to be used as a basis for designing or modifying other processes and structures for carrying out the same purposes and/or achieving the same advantages of the embodiments introduced herein. Those skilled in the art also realize that such equivalent constructions do not depart from the spirit and scope of embodiments described herein, and that various changes, substitutions, and alterations are able to be made without departing from the spirit and scope of the embodiments described herein.

What is claimed is:

1. A method for automatically optimizing parameters of a safety-critical system of interconnected subsystems, comprising:
selecting a representative sample data set for optimization of parameters of interconnected subsystems of a complex system using a hybrid data analytics approach;
breaking down a complexity of optimizing the complex system into interconnected subsystems by determining an order of the interconnected subsystems for optimization;
based on the order of the interconnected subsystems, exploring a parameter space of each of the interconnected subsystems to define an optimal configuration of the parameters of the interconnected subsystems for optimizing performance of the interconnected subsystems;
determining an overall optimal setting for the complex system of the interconnected subsystems based on an optimal configuration of the parameters of the interconnected subsystems; and
incorporating compliance to certification of a safety-critical system in the overall optimal setting for the complex system.

2. The method of claim 1, wherein the exploring the parameter space of each of the interconnected subsystems to define the optimal configuration of the parameters of the interconnected subsystems for optimizing performance of the interconnected subsystems includes:
performing sensitivity screening to define, in the parameters of each of the interconnected subsystems, space local regions of interest with promising performance;
from the local regions, determining a local optimal configuration for the parameters of each of the interconnected subsystems in each of the local regions by performing a numerical, iterative-based optimization;
comparing the local optimal configurations to find the global optimal configuration of each of the interconnected subsystems, and
validating the found global optimal configuration of each of the interconnected subsystems on leftover sample data not used in optimization.

3. The method of claim 2, wherein the determining the local optimal configuration for the parameters of the interconnected subsystems in each local region by performing the numerical, iterative-based optimization includes:
determining effects on an output of the interconnected subsystems in response to changing the parameters of the interconnected subsystems;
ranking the parameters of the interconnected subsystems based on the effects on the output of the interconnected subsystems in response to the changing the parameters of the interconnected subsystems; and
comparing values of the local optimal configuration of the parameters of the interconnected subsystems to determine values of a global optimal configuration for the complex system.

4. The method of claim 1, wherein the determining the order of the interconnected subsystems for optimization includes:
evaluating a change in the parameters of a first of the interconnected subsystems;
evaluating a change in an output of each other of the interconnected subsystems; and
for each of the interconnected subsystems determining:
a first score indicating a cumulative effect of a first of the interconnected subsystems on other subsystems;
a second score indicating a cumulative effect of the other of the interconnected subsystems on the first of the interconnected subsystems; and
an order optimization based on the first score indicating the first of the interconnected subsystems that has a greatest effect on the other of the interconnected subsystems in response to the change in the parameters of the first of the interconnected subsystems and the second score indicating the first of the interconnected subsystems that is least affected by the other of the interconnected subsystems in response to a cumulative change in the parameters of the other of the interconnected subsystems, or based on a combination of the first score and the second score.

5. The method of claim 1, wherein the selecting the representative sample data set for optimization of the parameters of the interconnected subsystems of the complex system using the hybrid data analytics approach includes:
applying clustering or unsupervised learning to further classify the representative sample data set into groups according to similarities in the representative sample data set;
performing statistical analysis for each of the groups; and
balancing the representative sample data set to ensure that no group in the groups is overrepresented in the representative sample data set,
wherein the performing the statistical analysis for each of the groups includes sampling data of each of the groups using machine learning, and including, in the representative sample data set, one or more of data of the groups exhibiting nominal behavior, trends in the data of the groups, or anomalous behavior in the data of the groups.

6. The method of claim 1, wherein the determining the overall optimal setting for the complex system of the interconnected subsystems includes:
ranking the parameters of the interconnected subsystems based on effects on an output of the interconnected subsystems in response to changing the parameters;
adjusting a highest ranked of the parameters having a greatest effect on the output of the interconnected subsystems in response to the changing the parameters; and
adjusting a next highest ranked of the parameters until further improvement is insignificant or target performance is achieved.

7. The method of claim 1, wherein the incorporating the compliance to the certification of the safety-critical system in the overall optimal setting for the complex system includes:
performing safety analysis of the interconnected subsystems;
based on the safety analysis, defining residual risk scenarios;
generating synthetic data for the residual risk scenarios;
for each of the residual risk scenarios, evaluating an output of the interconnected subsystems to determine a pass or failure of the interconnected subsystems in response to the synthetic data;
based on the pass or failure of the interconnected subsystem, determining a probability of the failure of the interconnected subsystems under the residual risk scenarios;
modeling a probability of failure distribution of the failure of the interconnected subsystems under the residual risk scenarios;
determining an upper bound of the probability of failure distribution of the failure of the interconnected subsystems under the residual risk;
based on the upper bound of the probability distribution, combining probabilities of failure of the interconnected subsystems to provide a combined probability of failure representing an overall probability of failure;
converting the overall probability of failure to a failure rate per hour;
comparing the failure rate per hour to a desired Tolerable Hazard Rate (THR) for a desired SIL integrity level; and
for the optimal configuration of the parameters of the interconnected subsystems, identifying success (failure rate≤THR) or failure for the parameters of the interconnected subsystems.

8. An apparatus for providing automated optimization for safety-critical system of interconnected subsystems, comprising:
a memory storing computer-readable instructions; and
a processor connected to the memory, wherein the processor is configured to execute the computer-readable instructions to perform operations to:
select a representative sample data set for optimization of parameters of interconnected subsystems of a complex system using a hybrid data analytics approach;
break down a complexity of optimizing the complex system into interconnected subsystems by determining an order of the interconnected subsystems for optimization;
based on the order of the interconnected subsystems, explore a parameter space of each of the interconnected subsystems to define an optimal configuration of the parameters of the interconnected subsystems for optimizing performance of the interconnected subsystems;
determine an overall optimal setting for the complex system of the interconnected subsystems based on an optimal configuration of the parameters of the interconnected subsystems; and
incorporate compliance to certification of a safety-critical system in the overall optimal setting for the complex system.

9. The apparatus of claim 8, wherein the processor is further configured to explore the parameter space of each of the interconnected subsystems to define the optimal configuration of the parameters of the interconnected subsystems for optimizing performance of the interconnected subsystems by:
performing sensitivity screening to define, in the parameters of each of the interconnected subsystems, space local regions of interest with promising performance;
from the local regions, determining a local optimal configuration for the parameters of each of the interconnected subsystems in each of the local regions by performing a numerical, iterative-based optimization;
comparing the local optimal configurations to find the global optimal configuration of each of the interconnected subsystems; and
validating the found global optimal configuration of each of the interconnected subsystems on leftover sample data not used in optimization.

10. The apparatus of claim 9, wherein the processor is further configured to determine the local optimal configuration for the parameters of the interconnected subsystems in each local region by performing the numerical, iterative-based optimization by:
determining effects on an output of the interconnected subsystems in response to changing the parameters of the interconnected subsystems;
ranking the parameters of the interconnected subsystems based on the effects on the output of the interconnected subsystems in response to the changing the parameters of the interconnected subsystems; and
comparing values of the local optimal configuration of the parameters of the interconnected subsystems to determine values of a global optimal configuration for the complex system.

11. The apparatus of claim 8, wherein the processor is further configured to determine the order of the interconnected subsystems for optimization by:
evaluating a change in the parameters of a first of the interconnected subsystems;
evaluating a change in an output of each other of the interconnected subsystems; and
for each of the interconnected subsystems determining:
a first score indicating a cumulative effect of a first of the interconnected subsystems on other subsystems;
a second score indicating a cumulative effect of the other of the interconnected subsystems on the first of the interconnected subsystems; and
an order optimization based on the first score indicating the first of the interconnected subsystems that has a greatest effect on the other of the interconnected subsystems in response to the change in the parameters of the first of the interconnected subsystems and the second score indicating the first of the interconnected subsystems that is least affected by the other of the interconnected subsystems in response to a cumulative change in the parameters of the other of the interconnected subsystems, or based on a combination of the first score and the second score.

12. The apparatus of claim 8, wherein the processor is further configured to select the representative sample data set for optimization of the parameters of the interconnected subsystems of the complex system using the hybrid data analytics approach by:
applying clustering or unsupervised learning to further classify the representative sample data set into groups according to similarities in the representative sample data set;
performing statistical analysis for each of the groups; and
balancing the representative sample data set to ensure that no group in the groups is overrepresented in the representative sample data set,
wherein the performing the statistical analysis for each of the groups includes sampling data of each of the groups using machine learning, and including, in the representative sample data set, one or more of data of the groups exhibiting nominal behavior, trends in the data of the groups, or anomalous behavior in the data of the groups.

13. The apparatus of claim 8, wherein the processor is further configured to determine the overall optimal setting for the complex system of the interconnected subsystems by:
ranking the parameters of the interconnected subsystems based on effects on an output of the interconnected subsystems in response to changing the parameters;
adjusting a highest ranked of the parameters having a greatest effect on the output of the interconnected subsystems in response to the changing the parameters; and
adjusting a next highest ranked of the parameters until further improvement is insignificant or target performance is achieved.

14. The apparatus of claim 8, wherein the processor is further configured to incorporate the compliance to the certification of the safety-critical system in the overall optimal setting for the complex system by:
performing safety analysis of the interconnected subsystems;
based on the safety analysis, defining residual risk scenarios;
generating synthetic data for the residual risk scenarios;
for each of the residual risk scenarios, evaluating an output of the interconnected subsystems to determine a pass or failure of the interconnected subsystems in response to the synthetic data;
based on the pass or failure of the interconnected subsystem, determining a probability of the failure of the interconnected subsystems under the residual risk scenarios;
modeling a probability of failure distribution of the failure of the interconnected subsystems under the residual risk scenarios;
determining an upper bound of the probability of failure distribution of the failure of the interconnected subsystems under the residual risk;
based on the upper bound of the probability distribution, combining probabilities of failure of the interconnected subsystems to provide a combined probability of failure representing an overall probability of failure;
converting the overall probability of failure to a failure rate per hour;
comparing the failure rate per hour to a desired Tolerable Hazard Rate (THR) for a desired SIL integrity level; and
for the optimal configuration of the parameters of the interconnected subsystems, identifying success (failure rate≤THR) or failure for the parameters of the interconnected subsystems.

15. A non-transitory computer-readable media having computer-readable instructions stored thereon, which when executed by a processor causes the processor to perform operations comprising:
selecting a representative sample data set for optimization of parameters of interconnected subsystems of a complex system using a hybrid data analytics approach;
breaking down a complexity of optimizing the complex system into interconnected subsystems by determining an order of the interconnected subsystems for optimization;
based on the order of the interconnected subsystems, exploring a parameter space of each of the interconnected subsystems to define an optimal configuration of the parameters of the interconnected subsystems for optimizing performance of the interconnected subsystems;
determining an overall optimal setting for the complex system of the interconnected subsystems based on an optimal configuration of the parameters of the interconnected subsystems; and
incorporating compliance to certification of a safety-critical system in the overall optimal setting for the complex system.

16. The non-transitory computer-readable media of claim 15, wherein:
the exploring the parameter space of each of the interconnected subsystems to define the optimal configuration of the parameters of the interconnected subsystems for optimizing performance of the interconnected subsystems includes:
performing sensitivity screening to define, in the parameters of each of the interconnected subsystems, space local regions of interest with promising performance;
from the local regions, determining a local optimal configuration for the parameters of each of the interconnected subsystems in each of the local regions by performing a numerical, iterative-based optimization;
comparing the local optimal configuration to find the global optimal configuration of each of the interconnected subsystems, and
validating the found global optimal configuration of each of the interconnected subsystems on leftover sample data not used in optimization.

17. The non-transitory computer-readable media of claim 15, wherein the determining the order of the interconnected subsystems for optimization includes:
evaluating a change in the parameters of a first of the interconnected subsystems;
evaluating a change in an output of each other of the interconnected subsystems; and
for each of the interconnected subsystems determining:
a first score indicating a cumulative effect of a first of the interconnected subsystems on other subsystems;
a second score indicating a cumulative effect of the other of the interconnected subsystems on the first of the interconnected subsystems; and
an order optimization based on the first score indicating the first of the interconnected subsystems that has a greatest effect on the other of the interconnected subsystems in response to the change in the parameters of the first of the interconnected subsystems and the second score indicating the first of the interconnected subsystems that is least affected by the other of the interconnected subsystems in response to a cumulative change in the parameters of the other of the interconnected subsystems, or based on a combination of the first score and the second score.

18. The non-transitory computer-readable media of claim 15, wherein the selecting the representative sample data set for optimization of the parameters of the interconnected subsystems of the complex system using the hybrid data analytics approach includes:
applying clustering or unsupervised learning to further classify the representative sample data set into groups according to similarities in the representative sample data set;
performing statistical analysis for each of the groups; and
balancing the representative sample data set to ensure that no group in the groups is overrepresented in the representative sample data set,
wherein the performing the statistical analysis for each of the groups includes sampling data of each of the groups using machine learning, and including, in the representative sample data set, one or more of data of the groups exhibiting nominal behavior, trends in the data of the groups, or anomalous behavior in the data of the groups.

19. The non-transitory computer-readable media of claim 15, wherein the determining the overall optimal setting for the complex system of the interconnected subsystems includes:
ranking the parameters of the interconnected subsystems based on effects on an output of the interconnected subsystems in response to changing the parameters;
adjusting a highest ranked of the parameters having a greatest effect on the output of the interconnected subsystems in response to the changing the parameters; and
adjusting a next highest ranked of the parameters until further improvement is insignificant or target performance is achieved.

20. The non-transitory computer-readable media of claim 15, wherein the incorporating the compliance to the certification of the safety-critical system in the overall optimal setting for the complex system includes:
performing safety analysis of the interconnected subsystems;
based on the safety analysis, defining residual risk scenarios;
generating synthetic data for the residual risk scenarios;
for each of the residual risk scenarios, evaluating an output of the interconnected subsystems to determine a pass or failure of the interconnected subsystems in response to the synthetic data;
based on the pass or failure of the interconnected subsystem, determining a probability of the failure of the interconnected subsystems under the residual risk scenarios;
modeling a probability of failure distribution of the failure of the interconnected subsystems under the residual risk scenarios;
determining an upper bound of the probability of failure distribution of the failure of the interconnected subsystems under the residual risk;
based on the upper bound of the probability distribution, combining probabilities of failure of the interconnected subsystems to provide a combined probability of failure representing an overall probability of failure;
converting the overall probability of failure to a failure rate per hour;
comparing the failure rate per hour to a desired Tolerable Hazard Rate (THR) for a desired SIL integrity level; and
for the optimal configuration of the parameters of the interconnected subsystems, identifying success (failure rate≤THR) or failure for the parameters of the interconnected subsystems.
